(19) United States
(12) Patent Application Publication
(10) Pub. No.: US 2001/0048736 A1
(43) Pub. Date: Dec. 6, 2001

(54) Communication system for delivering and managing content on a voice portal platform

(76) Inventors: David L. Walker, Tucson, AZ (US); Mark G. Mackelprang, Tucson, AZ (US); Andrew J. Sipe, Tucson, AZ (US)

Correspondence Address: James N. Kallis, Brooks & Kushman P.C., 1000 Town Center, 22nd Floor, Southfield, MI, 48075-1351, US

(21) Appl. No.: 09/874,171

(22) Filed: Jun. 4, 2001

Related U.S. Application Data
(60) Provisional application No. 60/209,508, filed on Jun. 5, 2000.

(51) Int. Cl. H04M 1/64

(52) U.S. Cl. 379/88.23

(57) ABSTRACT

A communication system for communicating content to a telephone user in response to a request for the content from the telephone user. The system includes a voice application operable for receiving a request from the telephone user for content and for generating a content request indicative of the content requested by the telephone user. A first consent provider is operable for periodically generating pushed content files and a second content provider is operable for generating on-demand content files. In response to receiving a content request from the voice application a content server is operable for providing content handlers having audio versions of pushed and on-demand content files related to the content requested by the telephone user from the content providers to the voice application. The voice application then plays the audio versions of the content files related to the content requested by the telephone user to the telephone user.

### CROSS-REFERENCE TO RELATED APPLICATIONS

This application claims the benefit of U.S. Provisional Application No. 60/209,508 filed Jun. 5, 2000.

### TECHNICAL FIELD

The present invention is generally related to communication systems employing voice portal platforms and, more particularly, to a communication system for delivering and managing content on a voice portal platform.

### BACKGROUND ART

Communication systems having voice portal platforms deliver audio versions of information and content from data sources to a telephone user. In operation, a telephone user calls a voice portal platform access telephone number and interacts with the voice portal platform of a communication system using natural voice commands. The telephone user interacts with the voice portal platform to request a wide variety of information types. The requested information may be in written text and audio formats which are provided to the voice portal platform by data sources such as the Internet for the telephone user. In the case of written text, the written text is converted into an audio format and then forwarded to the telephone user by the voice portal platform.

What is needed is a communication system for delivering any type of text or audio content through a single access point to a voice portal platform for a telephone user. Such a communication system would present a single, simple interface for a voice portal platform to obtain on-demand or stored content while hiding the details of how the content is retrieved from the data sources, is converted into an audio format (if the content is in a written text format), and is persisted based on intelligent aging rules. Further, such a communication system would simplify the development of voice applications as voice application developers would not need to customize the voice portal platform to adapt to each type of content. Additionally, such a communication system would allow telephone users to make a simple request for content and then deliver the content through a single access point for the telephone user.

### DISCLOSURE OF INVENTION

Accordingly, it is an object of the present invention to provide a communication system for delivering and managing content on a voice portal platform.

It is another object of the present invention to provide a communication system for delivering any type of text or audio content through a single access point to a voice portal platform for a telephone user.

It is a further object of the present invention to provide a communication system for delivering pushed and on-demand content through a single access point to a voice portal platform for a telephone user.

It is still a further object of the present invention to provide a communication system for delivering text files from a content provider through a single access point to a voice portal platform and then converting the text file into an audio file prior to delivery to the telephone user.

In carrying out the above objects and other objects, the present invention provides a communication system for communicating content to a telephone user in response to a request for the content from the telephone user. The system includes a voice application operable with the telephone user for receiving a request from the telephone user for content. The voice application is further operable for generating a content request indicative of the content requested by the telephone user. A first content provider is operable for periodically generating pushed content files and a second content provider is operable for generating on-demand content files. A content server is operable for receiving the content request from the voice application. In response to receiving a content request from the voice application the content server is operable for providing content handlers having audio versions of pushed and on-demand content files related to the content requested by the telephone user from the first and second content providers to the voice application. The voice application plays the audio versions of the pushed and on-demand content files related to the content requested by the telephone user to the telephone user in order to satisfy the request for content from the telephone user.

The content server has a content cache for receiving and then storing the pushed content files generated by the first content provider. In response to receiving a content request from the voice application the content server searches the content cache to determine if any of the stored pushed content files are related to the content requested by the telephone user. If a stored pushed content file is related to the content requested by the telephone user the content server generates and then provides a content handler having an audio version of the related stored pushed content file to the voice application. The voice application then plays the audio version of the related stored pushed content file to the telephone user in order to satisfy the request for content from the telephone user.

If none of the stored pushed content files are related to the content requested by the telephone user the content server determines if the second content provider provides an on-demand content file related to the content requested by the telephone user. If the second content provider provides an on-demand content file related to the content requested by the telephone user the content server receives the related on-demand content file from the second content provider and then generates a content handler having an audio version of the related on-demand content file. The voice application then plays the audio version of the related on-demand content file to the telephone user in order to satisfy the request for content from the telephone user.

A content factory may be operable with the second content provider for registering the second content provider with the content server in order to make the content server aware of the type of on-demand content provided by the second content provider.

The pushed content files may be text files and the content server converts the text of the pushed content files into audio in order to provide content handlers having audio versions of the pushed context files. The on-demand content files may be text files and the content server converts the text of the on-demand content files into audio in order to provide content handlers having audio versions of the on-demand content files.

At least one of the first and second content providers may be web-based content providers. The first content provider may be a news story provider and the pushed content files are news stories. The second content provider may be a stock quote provider and the on-demand content files are stock quotes; an email provider and the on-demand content files are emails; and a weather condition provider and the on-demand content files are weather conditions.

The request for content from the telephone user may be an audio request and the voice application is operable for converting the audio request into the content request. The request for content from the telephone user may be a dual tone multi-frequency request and the voice application is operable for converting the dual tone multi-frequency request into the content request.

Further, in carrying out the above objects and other objects, the present invention provides a communication system for communicating content to a telephone user in response to a request for the content from the telephone user. The system includes a voice application operable with the telephone user for receiving a request from the telephone user for content. The voice application is further operable for generating a content request indicative of the content requested by the telephone user. A first content provider is operable for periodically generating pushed content files and a second content provider is operable for generating on-demand content files. A content server is operable for receiving the content request from the voice application. The content server is operable with the first content provider for receiving as they are generated by the first content provider and then storing the pushed content files. The content server is operable with the second content provider for receiving on-demand content files on request.

In response to receiving a content request from the voice application the content server is operable to determine if any of the stored pushed content files are related to the content requested by the telephone user. If a stored pushed content file is related to the content requested by the telephone user the content server generates and then provides a content handler having an audio version of the related stored pushed content file to the voice application. The voice application then plays the audio version of the related stored pushed content file to the telephone user in order to satisfy the request for content from the telephone user.

If none of the stored pushed content files are related to the content requested by the telephone user the content server determines if the second content provider provides an on-demand content file related to the content requested by the telephone user. If the second content provider provides an on-demand content file related to the content requested by the telephone user the content server requests and receives the related on-demand content file from the second content provider and then generates a content handler having an audio version of the related on-demand content file. The voice application then plays the audio version of the related on-demand content file to the telephone user in order to satisfy the request for content from the telephone user.

The pushed content files may be text files and the content server converts the pushed content text files into pushed content audio files and then stores the pushed content audio files. The pushed content files may be audio files. The related on-demand content file may be a text file and the content server converts the related on-demand content text file into an on-demand context audio file in order to generate the content handler having the audio version of the related on-demand content file.

The above objects and other objects, features, and advantages of the present invention are readily apparent from the following detailed description of the best mode for carrying out the present invention when taken in connection with the accompanying drawings.

### BRIEF DESCRIPTION OF DRAWINGS

FIG. 1 illustrates a block diagram of a communication system in accordance with a preferred embodiment of the present invention; and

FIG. 2 illustrates in greater detail the communication system shown in FIG. 1.

### BEST MODE FOR CARRYING OUT THE INVENTION

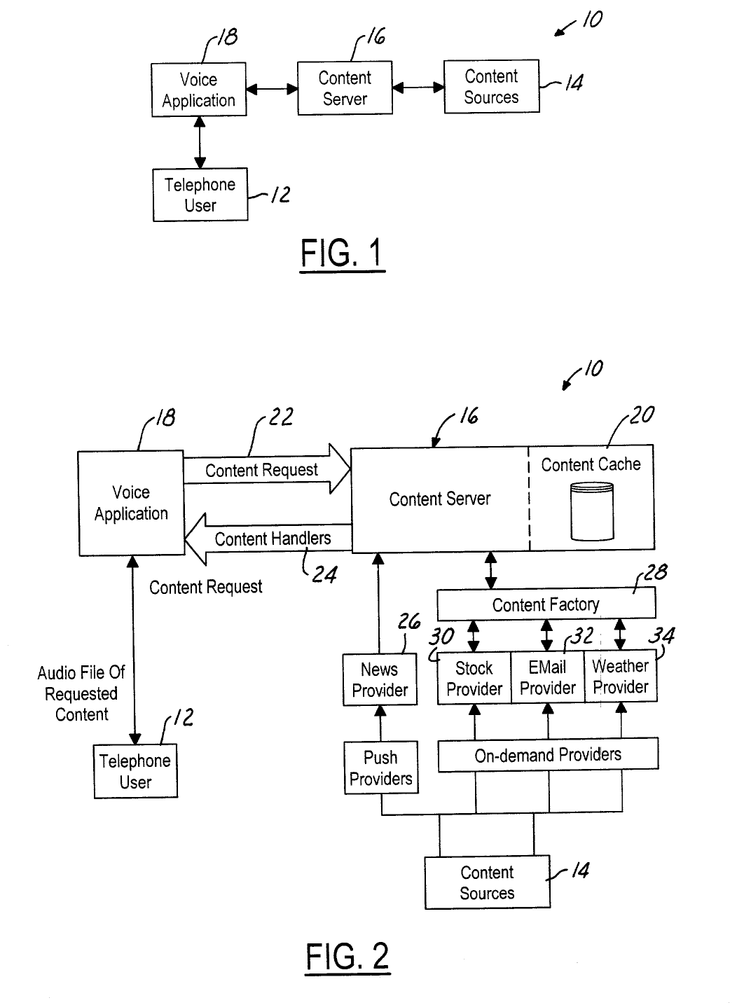

Referring now to FIG. 1, a block diagram of a communication system 10 in accordance with a preferred embodiment of the present invention is shown. Communication system 10 is a voice portal platform for enabling a telephone user 12 to request and access information, i.e., content, such as written text files and audio files from content sources 14. Content sources 14 create various types of content such as email, news, weather conditions, sport scores, stock quotes, movie listings, schedules, company reports, driving directions, product prices, horoscopes, and the like. In response to a request for content from telephone user 12, a content server 16 of communication system 10 locates the requested content from content sources 14. Content server 16 then provides an audio version of the requested content to telephone user 12 via a voice application 18 in order to satisfy the telephone user's request for the content. If the requested content created by a content source 14 is in the form of written text file then content server 16 converts the written text file into an audio file and then provides the audio file to voice application 18. Voice application 18 then plays the audio file for telephone user 12. If the requested content created by a content source 14 is in the form of an audio file then content server 16 provides the audio file to voice application 18 which then plays the audio file for telephone user 12.

Telephone user 12 may be a wired or wireless telephone user. The request for content from telephone user 12 to voice application 18 may be performed by the telephone user speaking an audible request or using digital signaling such as dual tone multi-frequency (DTMF) touch tone dialing. In response to an audible request from telephone user 12, voice application 18 uses automatic speech recognition capability for understanding the audible request to determine the requested content. Similarly, voice application 18 is functional to understand a DTMF request from telephone user 12 to determine the requested content.

Referring now to FIG. 2, a more detailed block diagram of communication system 10 is shown. Generally, communication system 10 allows content to be made available to voice application 18 through a single access point, i.e., content server 16. Voice application 18 is the call flow software for communication system 10. Voice application 18 interacts with telephone user 12 by playing prompts for the telephone user, requesting content server 16 to provide content to satisfy the telephone user's request for content, playing the content delivered by the content server from content sources 14 to the telephone user, and the like.

In response to a request for content from telephone user 12, voice application 18 transmits a content request 22 to content sever 16. Content request 22 is indicative of telephone user's 12 request for content and contains information indicative of the type of content requested (e.g., stock quotes, email, world news stories, etc.) and the telephone user. The information indicative of telephone user 12 enables content request 22 to be personalized for the specific telephone user. For example, this allows content server 16 to retrieve email for the specific telephone user and then provide the email to the telephone user via voice application 18.

In response to receiving content request 22 from voice application 18, content server 16 transmits a content handler 24 to the voice application. Content handler 24 includes objects that can be played by voice application 18 to produce audio content for telephone user 12 in order to satisfy the telephone user's request for the content. Content handler 24 is specific to the content type requested in content request 22. For instance, content handler 24 may be a news content handler or an email content handler. News content handlers include objects which have the ability to play audio versions of news stories for telephone user 12. Email content handlers include objects which have the ability to play audio versions of email for telephone user 12 while allowing the telephone user to delete and forward the email.

Content server 16 is the interface, or single access point, between telephone user 12 and content sources 14. Generally, content server 16 is operable to store content from content sources 14 and operate in conjunction with the content sources to create content for delivery to telephone user 12. Content server 16 is operable to receive content from content sources 14 in two ways. First, content sources 14 push content onto the content server 16 which then stores the pushed content in a content cache 20. Second, content sources 14 register with content server 16 to inform the content server that content can be delivered on-demand, i.e., the content can be created by the content sources in response to a request by content server.

An example of pushed content are news stories. Content sources 14 such as a news provider 26 push news stories, perhaps a dozen headline stories for example, onto content server 16. Content cache 20 of content server 16 stores the news stories for a predetermined amount of time and then removes the news stories once they become old. Content sources 14 continually provide news stories to content server 16 for storage in content cache 20 whenever news stories are updated and available.

Content cache 20 stores pushed content until the pushed content expires. The expiration length of time is set per content type. In response to a content request 22 from telephone user 12, content server 16 searches content cache 20 for the requested content before attempting to create the requested content.

In operation, if telephone user 12 requests voice application 18 to read a news story related to a news event to the telephone user the voice application transmits content request 22 to content server 16 for a news story related to the news event. Content server 16 then attempts to locate a news story related to the news event in content cache 20. If content cache 20 has a suitable news story, then content server 16 retrieves the news story from the content cache and returns a content handler 24 containing the news story in an audio format to voice application 18 for deliver to telephone user 12. The news story may be stored in content cache 20 in either a written text format or an audio format.

If news provider 26 provides the news story to content server 16 in a written text format then the content server may convert the written text version of the news story into an audio format and then store the audio version of the news story in content cache 20. Content server 16 includes a text-to-speech (TTS) system to convert written text into audio. Similarly, content cache 20 may store the news story in the written text format and then content server 16 converts the news story into the audio format using the TTS system. In this case, content server 16 provides a content handler 24 containing an audio version of the news story to voice application 18 in response to a content request 22. If news provider 26 provides the news story to content server 16 in an audio format then content cache 20 stores the audio version of the news story. In this case, content server 16 provides a content handler 24 containing the audio version of the news story to voice application 18 in response to a content request 22 without any TTS conversion.

An example of on-demand content is a stock quote which changes constantly. In this case, specific stock content is requested by telephone user 12 on-demand. In response to a content request 22 requesting on-demand content, content server 16 initially looks into content cache 20 to see if the content cache contains the requested on-demand content. If content cache 20 does not contain the requested on-demand content, then content server 16 requests a content factory 28 operable with content sources 14 to create the requested on-demand content. In general, content factory 28 is responsible for creating all the disparate on-demand content types. Content factory 28 creates on-demand content by allowing on-demand content providers to register their ability to create content with the content factory. Content factory 28 then doles out on-demand content requests to the on-demand content providers when requests for on-demand content creation arrive from content server 16.

In operation, each on-demand content provider such as a stock provider 30, an email provider 32, and a weather provider 34 registers with content factory 28 to inform the content factory and content server 16 that the on-demand content providers can create on-demand content. In response to a request for on-demand content from content server 16, content factory 28 determines if a suitable on-demand content provider is registered with the content factory. If so, content factory 28 queries the suitable on-demand content provider for the requested on-demand content. Content factory 28 then provides the on-demand content from the on-demand content provider to content server 16. If the provided on-demand content is in a written text format then content server 16 converts the written text format into an audio format using the TTS system. Content server 16 then provides a content handler 24 containing the audio format of the on-demand content to voice application 18 for delivery to telephone user 12. If the provided on-demand content is already in an audio format then content server 16 provides a content handler 24 containing the audio format of the on-demand content to voice application 18 for delivery to telephone user 12 without any TTS conversion.

In the case of a request for a stock quote, content factory 28 queries stock provider 30 for the stock quote and then provides the stock quote from the stock provider to content server 16. Content server 16 then forwards a content handler 24 containing the audio format of the stock quote to voice application 18 for delivery to telephone user 12 in the manner described above.

With reference to FIG. 2, a step-by-step description of the sequences for initializing communication system 10 for a telephone user 12 to request and receive content will now be described. The content initialization sequence is as follows. Initially, content server 16 and content factory 28 start up. Each content provider 26, 30, 32, and 34 then starts up. As content providers 26, 30, 32, and 34 come on-line each informs content server 16 of the expiration age of the content that they will provide. On-demand content providers such as content providers 30, 32, and 34 register with content factory 28. On-demand content providers 30, 32, and 34 wait for a content request from content server 16 via content factory 28. Push content providers such as news content provider 26 periodically create content and transfer the content to content server 16 which then stores the content in content cache 20.

The content request sequence is as follows. Initially, telephone user 12 transfers a request for content to voice application 18. Voice application 18 then creates a content request 22 and transfers the content request to content server 16. Content request 22 contains the desired content type and identification of telephone user 12. In response to receiving content request 22, content server 16 examines content cache 20 to determine if the content cache has content that matches the desired content type for telephone user 12. If a match is found, content server 16 transfers a content handler 24 containing an audio version of the requested content to voice application 18 for delivery to telephone user 12.

If no matches are found, then content server 16 forwards content request 22 to content factory 28. If content factory 28 has a content provider registered with the content factory which knows how to create content to satisfy content request 22 then the content request is forwarded on to that specific content provider. Once the specific content provider receives content request 22 it returns a list of content items that match the content request to content server 16 via content factory 28. Content server 16 then transfers a content handler 24 containing an audio version of a requested content item to voice application 18 for delivery to telephone user 12.

Thus it is apparent that there has been provided, in accordance with the present invention, a communication system for delivering and managing content on a voice portal platform that fully satisfies the objects, aims, and advantages set forth above. While the present invention has been described in conjunction with specific embodiments thereof, it is evident that many alternatives, modifications, and variations will be apparent to those skilled in the art in light of the foregoing description. Accordingly, it is intended to embrace all such alternatives.

What is claimed is:

1. A communication system for communicating content to a telephone user in response to a request for the content from the telephone user, the system comprising:
a voice application operable with the telephone user for receiving a request from the telephone user for content, the voice application further operable for generating a content request indicative of the content requested by the telephone user;
a first content provider operable for periodically generating pushed content files;
a second content provider operable for generating on-demand content files; and
a content server operable for receiving the content request from the voice application, wherein in response to receiving a content request from the voice application the content server is operable for providing content handlers having audio versions of pushed and on-demand content files related to the content requested by the telephone user from the first and second content providers to the voice application, wherein the voice application plays the audio versions of the pushed and on-demand content files related to the content requested by the telephone user to the telephone user in order to satisfy the request for content from the telephone user.

2. The system of claim 1 wherein:
the content server has a content cache for receiving and then storing the pushed content files generated by the first content provider.

3. The system of claim 2 wherein:
in response to receiving a content request from the voice application the content server searches the content cache to determine if any of the stored pushed content files are related to the content requested by the telephone user, wherein if a stored pushed content file is related to the content requested by the telephone user the content server generates and then provides a content handler having an audio version of the related stored pushed content file to the voice application, wherein the voice application then plays the audio version of the related stored pushed content file to the telephone user in order to satisfy the request for content from the telephone user.

4. The system of claim 3 wherein:
if none of the stored pushed content files are related to the content requested by the telephone user the content server determines if the second content provider provides an on-demand content file related to the content requested by the telephone user, wherein if the second content provider provides an on-demand content file related to the content requested by the telephone user the content server receives the related on-demand content file from the second content provider and then generates a content handler having an audio version of the related on-demand content file, wherein the voice application then plays the audio version of the related on-demand content file to the telephone user in order to satisfy the request for content from the telephone user.

5. The system of claim 4 further comprising:
a content factory operable with the second content provider for registering the second content provider with the content server in order to make the content server aware of the type of on-demand content provided by the second content provider.

6. The system of claim 1 wherein:
the pushed content files are text files, wherein the content server converts the text of the pushed content files into audio in order to provide content handlers having audio versions of the pushed context files.

7. The system of claim 1 wherein:
the on-demand content files are text files, wherein the content server converts the text of the on-demand content files into audio in order to provide content handlers having audio versions of the on-demand content files.

8. The system of claim 1 wherein:
at least one of the first and second content providers are web-based content providers.

9. The system of claim 1 wherein:
the first content provider is a news story provider and the pushed content files are news stories.

10. The system of claim 1 wherein:
the second content provider is a stock quote provider and the on-demand content files are stock quotes.

11. The system of claim 1 wherein:
the second content provider is an email provider and the on-demand content files are emails.

12. The system of claim 1 wherein:
the second content provider is a weather condition provider and the on-demand content files are weather conditions.

13. The system of claim 1 wherein:
the request for content from the telephone user is an audio request, wherein the voice application is operable for converting the audio request into the content request.

14. The system of claim 1 wherein:
the request for content from the telephone user is a dual tone multi-frequency request, wherein the voice application is operable for converting the dual tone multi-frequency request into the content request.

15. A communication system for communicating content to a telephone user in response to a request for the content from the telephone user, the system comprising:
a voice application operable with the telephone user for receiving a request from the telephone user for content, the voice application further operable for generating a content request indicative of the content requested by the telephone user;
a first content provider operable for periodically generating pushed content files;
a second content provider operable for generating on-demand content files; and
a content server operable for receiving the content request from the voice application, the content server operable with the first content provider for receiving as they are generated by the first content provider and then storing the pushed content files, the content server operable with the second content provider for receiving on-demand content files on request;
wherein in response to receiving a content request from the voice application the content server is operable to determine if any of the stored pushed content files are related to the content requested by the telephone user, wherein if a stored pushed content file is related to the content requested by the telephone user the content server generates and then provides a content handler having an audio version of the related stored pushed content file to the voice application, wherein the voice application then plays the audio version of the related stored pushed content file to the telephone user in order to satisfy the request for content from the telephone user;
wherein if none of the stored pushed content files are related to the content requested by the telephone user the content server determines if the second content provider provides an on-demand content file related to the content requested by the telephone user, wherein if the second content provider provides an on-demand content file related to the content requested by the telephone user the content server requests and receives the related on-demand content file from the second content provider and then generates a content handler having an audio version of the related on-demand content file, wherein the voice application then plays the audio version of the related on-demand content file to the telephone user in order to satisfy the request for content from the telephone user.

16. The system of claim 15 further comprising:
a content factory operable with the second content provider for registering the second content provider with the content server in order to make the content server aware of the type of on-demand content provided by the second content provider.

17. The system of claim 15 further comprising:
a third content provider for operable for generating on-demand content files, wherein the first content provider generates pushed content files of a first type, the second content provider generates on-demand content files of a second type, and the third content provider generates on-demand content files of a third type.

18. The system of claim 15 wherein:
the pushed content files are text files, wherein the content server converts the pushed content text files into pushed content audio files and then stores the pushed content audio files.

19. The system of claim 15 wherein:
the pushed content files are audio files.

20. The system of claim 15 wherein:
the related on-demand content file is a text file, wherein the content server converts the related on-demand content text file into an on-demand context audio file in order to generate the content handler having the audio version of the related on-demand content file.
